(19) United States
(12) Patent Application Publication
(10) Pub. No.: US 2008/0078620 A1
(43) Pub. Date: Apr. 3, 2008

(54) Main shaft lubricating device

(76) Inventor: Naomitsu Yanohara, Aichi (JP)

Correspondence Address: JACOBSON HOLMAN PLLC, 400 SEVENTH STREET N.W., SUITE 600, WASHINGTON, DC, 20004, US

(21) Appl. No.: 11/905,697

(22) Filed: Oct. 3, 2007

(30) Foreign Application Priority Data
Oct. 3, 2006 (JP) 2006-271596

(51) Int. Cl. B23Q 11/12

(52) U.S. Cl. 184/6.14

(57) ABSTRACT

It is an object of the present invention to provide a main shaft lubricating device in which in a machine tool, a temperature variation around a machine is taken into account. A main shaft lubricating device of a machine tool including a temperature sensor for detecting a temperature around a machine, a speed sensor for detecting a rotation speed of a main shaft, supply device for supplying a lubricant oil to a bearing of the main shaft such that a supply amount thereof can be varied, and calculating section for calculating the supply device by the supply device based on an output signals of the temperature sensor and the speed sensor.

### BACKGROUND OF THE INVENTION

1. Field of the Invention

The present invention relates to a main shaft lubricating device for lubricating a bearing of a main shaft of a machine tool for example.

2. Description of the Related Art

As a main shaft lubricating device of this kind, there has been a known lubricating device including a temperature sensor for detecting a temperature of an outer wheel or an inner wheel of a bearing of the main shaft or a temperature of a housing near the bearing of the main shaft, a speed sensor for detecting a rotation speed of the main shaft, supply means for supplying a lubricant oil to the main shaft such that the supply amount can be varied, and calculating means for calculating the supply amount by the supply means based on output signals from the temperature sensor and the speed sensor (see, for example, Japanese Patent Application Laid-open No. 2004-76783 or Japanese Patent Application Laid-open No. H3-196942).

In a conventional device, even if a temperature around a machine, i.e., a temperature of a lubricant oil storage tank or a pipe and the like of the lubricant oil supply device is changed, and the temperature of the lubricant oil is changed, a case in which viscosity of the lubricant oil is changed is not taken into account. The tank and the pipe or the like are not formed with cover and the like, and the temperature is the same as that around these members. The temperature of the lubricant oil until the lubricant oil is supplied to the bearing is influenced by them.

Therefore, even if the temperature of the lubricant oil is changed and the rotation speed of the main shaft is not changed, if the temperature around the machine is changed, there is a possibility that the temperature of the bearing of the main shaft becomes high and at the worst, lubricant failure occurs and the bearing is damaged.

### SUMMARY OF THE INVENTION

It is an object of the present invention to provide a main shaft lubricating device in which in a machine tool, a temperature variation around a machine is taken into account.

A main shaft lubricating device of a machine tool according to the present invention includes a temperature sensor for detecting a temperature around a machine, a speed sensor for detecting a rotation speed of a main shaft, supply means for supplying the lubricant oil to a bearing of the main shaft such that a supply amount thereof can be varied, and calculating means for calculating the supply means by the supply means based on an output signals of the temperature sensor and the speed sensor.

According to the main shaft lubricating device of the machine tool of the invention, the temperature sensor detects a temperature around the machine, and an appropriate amount of the lubricant oil is supplied to the bearing of the main shaft based on output signals from the temperature sensor and the speed sensor. Therefore, there is provided a main shaft lubricating device in which variation in a temperature around the machine is taken into account.

Further, since the calculation is always carried out by the calculating means based on the predetermined calculation equation, an optimal supply amount for the lubricant oil is automatically calculated.

Further, calculation by the calculating means may be carried out by reading a predetermined value from a recorded database. The amount of calculations is reduced and a load o the control device can be reduced.

It is also possible to determined an amount of the lubricant oil to be supplied in the value determined by the temperature around the machine and the rotation speed of the main shaft by reflecting information from the device which is disposed in a path of the device which supplies the lubricant oil to the bearing and which always detects the lubricant oil amount while taking the temperature around the machine into account.

According to the present invention, it is possible to provide a main shaft lubricating device in which in a machine tool, a temperature variation around the machine is taken into account.

### BRIEF DESCRIPTION OF THE DRAWINGS

FIG. 1 is a block diagram showing a structure of a main shaft lubricating device of the invention;

FIG. 2 is a graph showing a relation between a temperature around a machine and lubricant oil discharging time;

FIG. 3 is a table showing a lubricant oil discharging interval as database; and

FIG. 4 is a diagram of structure showing a detection principle of a detector.

### DETAILED DESCRIPTION OF THE PREFERRED EMBODIMENT

An embodiment of the present invention will be explained with reference to the drawings.

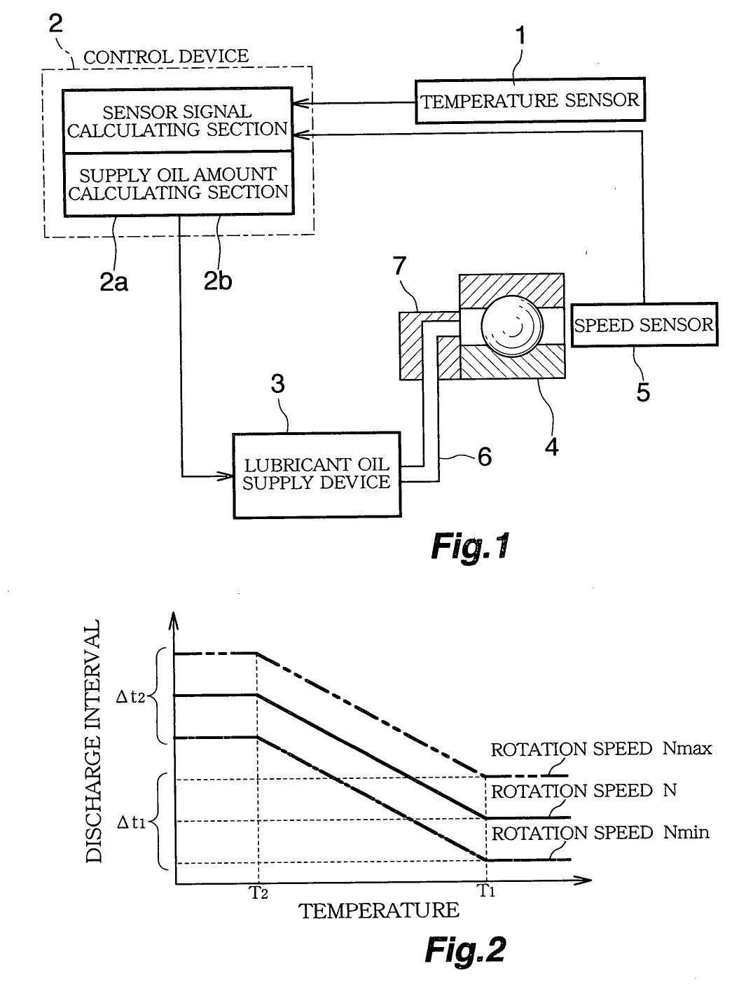

Referring to FIG. 1, a main shaft lubricating device includes an antifriction bearing 4 which supports a main shaft (not shown) of a machine tool, a lubricant oil supply device 3 which supplies a lubricant oil to the antifriction bearing 4, and a control device 2 which controls the lubricant oil supply device 3.

The lubricant oil supply device 3 can change the supply amount by elongating or shortening a discharging interval of the lubricant oil. The lubricant oil supply device 3 is connected to speacer 7 of the bearing 4 by the supply pipe 6.

The control device 2 includes a sensor signal calculating section 2b and a supply oil amount calculating section 2a. Output signals of the temperature sensor 1 and the speed sensor 5 are input to the sensor signal calculating section 2b. The temperature sensor 1 detects the temperature around the machine. The speed sensor 5 detects a rotation speed of the main shaft. The supply oil amount calculating section 2a calculates an appropriate supply amount of the lubricant oil based on a calculation result of the sensor signal calculating section 2b. The calculation result is taken into the lubricant oil supply device 3.

A manner for automatically obtaining a supply amount of the lubricant oil calculated by the supply oil amount calculating section 2a will be explained concretely.

Information of the temperature sensor 1 is taken into the supply oil amount calculating section 2a when the main shaft is not rotating, but lubricating operation is not carried out and the lubricant oil supply device 3 is stopped.

If a rotation command is issued to the main shaft from the control device 2, a supply oil amount is determined from a relation between a temperature around the machine and a rotation speed of the main shaft by the supply oil amount calculating section 2a, and the lubricant oil supply device 3 supplies the lubricant oil to the bearing 4.

For example, in the case where the temperature around the machine is high and the main shaft rotation speed is equal to or lower than a certain speed, a great amount of the lubricant oil is supplied to form an oil film and when the main shaft rotation speed is equal to or higher than a certain speed, the supply amount is reduced to a value such that the supply operation of the lubricant oil is not interrupted.

Calculation equations of the lubricant oil supply amount will be explained next. If set time of a lubricant oil discharging interval by the lubricant oil supply device 3 is defined as Δt and the temperature around the machine is defined as T, the set time Δt of the lubricant oil can be expressed by the following equations:

Δt=A×(1/N)B×T₂C+D×N:(T<T₂)

Δt=A×(1/N)B×TC+D×N:(T₁<T<T₂)

Δt=A×(1/N)B×T₁C+D×N:(T>T₁)

wherein, N: rotation speed, T₁: upper limit set temperature, T₂: lower limit set temperature, and A, B, C and D: constants.

FIG. 2 shows calculation results obtained by the above equations as examples. A vertical axis shows the set time Δt of the discharge interval, and the horizontal axis shows the temperature T around the machine.

The temperature around the machine becomes higher rightward on the horizontal axis and the viscosity of the lubricant oil is lowered and thus, the lubricant oil discharge interval is set short, and the lubricant oil discharge interval becomes Δt₁ when the set temperature becomes equal to or higher than T₁.

The lubricant oil discharge interval is also changed in accordance with the change in the rotation speed. Then, if the rotation speed is increased, the discharge interval is increased to reduce the lubricant oil supply amount, and if the rotation speed is reduced, the discharge interval is shortened to increase the lubricant oil supply amount.

In this case also, the rotation speeds Nmin and Nmax are the respective lower limit value and upper limit value, and when the rotation speed is equal to or lower than the lower limit value and equal to or higher than the upper limit value, the discharge interval is the same as the case where Nmin and Nmax.

Although the supply amount is changed when the discharge interval is changed in the above example, an oil amount per unit time may be directly obtained.

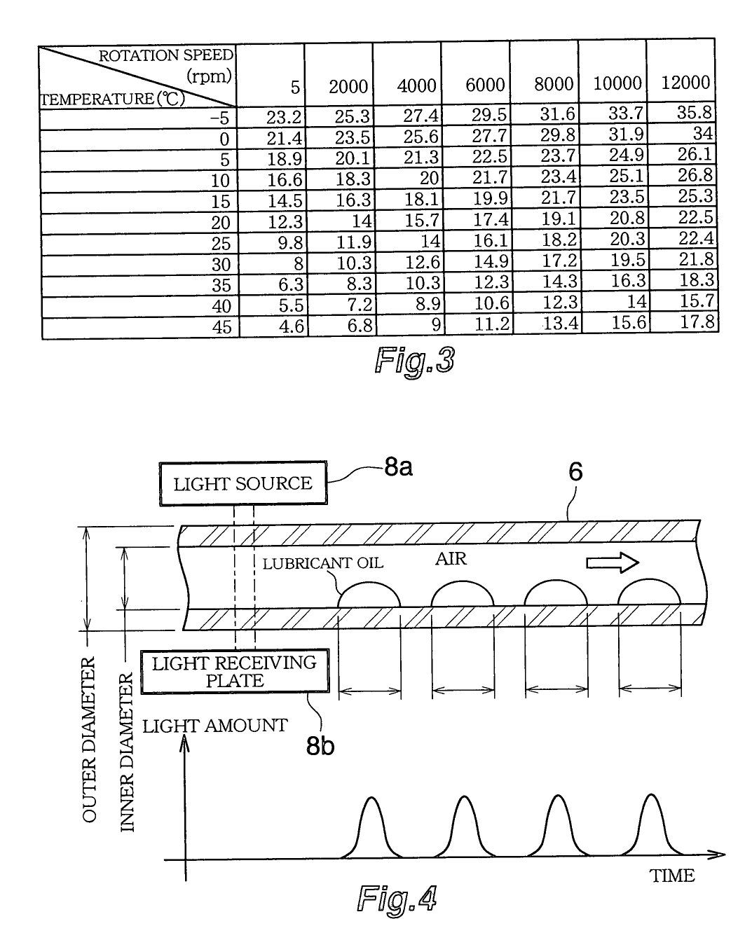

The lubricant oil supply amount may be determined by a database shown in FIG. 3 instead of obtaining from the calculation equations. FIG. 3 shows the lubricant oil discharge intervals under conditions of the temperatures around the machine arranged vertically and rotation speeds of the bearing arranged laterally. When the temperature around the machine is 20° C. and the bearing rotation speed is 6000 rpm, the lubricant oil discharge interval is 17.4 min. Here, in the case where the temperature around the machine is 22° C. and the bearing rotation speed is 7000 rpm, i.e., when a condition is different from those shown in FIG. 3, if a linear complement is performed, the lubricant oil discharge interval becomes 18.3 min. This database value may be a value which is previously obtained by a calculation equation or may be an actually measured value which is obtained by experiment.

FIG. 4 shows a detection principle of a device which always detects a lubricant oil amount.

This detector includes a light source 8a which generates light, a light receiving plate 8b which receives the light, a device (not shown) which supplies a power supply to the light source 8a and the light receiving plate 8b, and a control device (not shown) which controls the light source 8a and the light receiving plate 8b. This device is disposed near the bearing 4 of the lubricant oil supply pipe 6 as close as possible.

According to this device, a lubrication amount is detected by utilizing a difference between air flowing through the lubricant oil supply pipe 6 and light transmittance of the lubricant oil. In the case where the lubricant oil passes through the detector, the detector outputs a signal, and in case where air passes through the detector, the detector does not output a signal. With this configuration, an amount of the lubricant oil flowing through the lubricant oil supply pipe within unit time can be found.

Due to influence of viscosity of the lubricant oil which is changed by the temperature around the machine, a change of a signal detected by the device is reflected to a value obtained by taking the temperature around the machine into the control device and detected. For example, in the case where the temperature around the machine becomes low and the viscosity of the lubricant oil is increased, grain of the lubricant oil flowing through the lubricant oil supply pipe 6 becomes large, and the amount of the lubricant oil with respect to one detection is increased. When the temperature around the machine becomes high, opposite situation occurs. In the case where a value determined by the temperature around the machine and the rotation speed of the main shaft and a value detected by this device are different from each other, the supply amount is adjusted such that these values become equal to each other.

The above-described detector is an optical detector, but a detector utilizing infrared rays or magnetic field may be used instead.

1. A main shaft lubricating device of a machine tool comprising a temperature sensor for detecting a temperature around a machine, a speed sensor for detecting a rotation speed of a main shaft, supply means for supplying a lubricant oil to a bearing of the main shaft such that a supply amount of the lubricant oil can be varied, and calculating means for calculating the supply means by the supply means based on an output signals of the temperature sensor and the speed sensor.

2. The main shaft lubricating device of the machine tool according to claim 1, wherein calculation by the calculating means is carried out based on a predetermined calculation equation.

3. The main shaft lubricating device of the machine tool according to claim 1, wherein calculation by the calculating means is carried out by reading a predetermined value from a recorded database.

4. The main shaft lubricating device of the machine tool according to claim 1, further comprising a device for always detecting a lubricant oil amount in a path of a device for supplying the lubricant oil to the bearing while taking a temperature around the machine into account.
